(19) United States
(12) Patent Application Publication
(10) Pub. No.: US 2016/0364732 A1
(43) Pub. Date: Dec. 15, 2016

(54) ELECTRONIC PROVISIONING OF AUTOMATED CUSTOMER SERVICE

(71) Applicant: Arun Jagatheesan, San Jose, CA (US)

(72) Inventor: Arun Jagatheesan, San Jose, CA (US)

(21) Appl. No.: 15/181,365

(22) Filed: Jun. 13, 2016

Related U.S. Application Data
(60) Provisional application No. 62/174,452, filed on Jun. 11, 2015.

(51) Int. Cl. G06Q 30/00; H04L 29/06; H04L 29/08

(52) U.S. Cl. CPC G06Q 30/016; H04L 67/22; H04L 67/24; H04L 67/42

(57) ABSTRACT

A method includes issuing a customer service request for a mobile electronic device. Customer preferences are obtained for the issued customer service request. A match between the obtained customer preferences and at least one of a business preference and rules is dynamically determined. Signals provided by the mobile electronic device and electronic devices in a venue are dynamically monitored to determine one or more patterns for the mobile electronic device. At least one service communication channel and a service provider are assigned for the customer service request to provide interaction between the service provider and the mobile electronic device based on the match, the one or more patterns and service provider availability.

### CROSS-REFERENCE TO RELATED APPLICATIONS

This application claims the priority benefit of U.S. Provisional Patent Application Ser. No. 62/174,452, filed Jun. 11, 2015, incorporated herein by reference in its entirety.

### FIELD

One or more embodiments are directed to receiving and providing personalized customer service through one or more possible channels of interaction, such as direct face-to-face interactive service and multiple forms of digital interactive services. Using one or more embodiments, consumers have an option to form their own personalized logical team of individual employees in a business, as their personal “service heroes”. Businesses will try to serve or interact with consumers as much as possible with the service heroes selected by the consumers.

### BACKGROUND

Customer service involves one or more interactions between a customer and a business provider.

Presently there is no solution that can combine the best human experience that can be provided using face-to-face customer service with other forms of customer service without any tradeoffs. In large scale companies, there is no solution to digitally select the exact person or a group of people from whom the customer prefers to have customer service. There needs to be a way to seamlessly deliver customer service using one or more channels of human interaction without making any compromises on cost-efficiency, ease-of-use, and long-term relationship with the person of contact representing a business.

### SUMMARY

One embodiment includes a method comprising issuing a customer service request for a mobile electronic device. Customer preferences are obtained for the issued customer service request. A match between the obtained customer preferences and at least one of a business preference and rules is dynamically determined. Signals provided by the mobile electronic device and electronic devices in a venue are dynamically monitored to determine one or more patterns for the mobile electronic device. At least one service communication channel and a service provider are assigned for the customer service request to provide interaction between the service provider and the mobile electronic device based on the match, the one or more patterns and service provider availability.

Another embodiment comprises A computer program product for managing customer service requests. The computer program product comprising a computer readable storage device having program instructions embodied therewith. The program instructions executable by a processor to cause the processor to: issue a customer service request for a mobile electronic device; obtain customer preferences for the issued customer service request; dynamically determine a match between the obtained customer preferences with at least one of a business preference and rules; dynamically monitor signals provided by the mobile electronic device and electronic devices in a venue to determine one or more patterns for the mobile electronic device; and assign at least one service communication channel and a service provider for the customer service request to provide interaction between the service provider and the mobile electronic device based on the match, the one or more patterns and service provider availability.

In yet another embodiment, a system comprises a memory storing instructions. At least one processor executes the instructions including obtaining a customer service request for a mobile electronic device, obtaining customer preferences for the customer service request, determining a match for the customer preferences with at least one of a business preference and rules, determining one or more patterns for the mobile electronic device based on monitoring signals provided by the mobile electronic device and electronic devices in a venue, and assigning at least one service communication channel and a service provider for the customer service request to provide interaction between the service provider and the mobile electronic device based on the match, the one or more patterns and service provider availability.

### BRIEF DESCRIPTION OF THE DRAWINGS

For a fuller understanding of the nature and advantages of the embodiments, as well as a preferred mode of use, reference should be made to the following detailed description read in conjunction with the accompanying drawings, in which:

FIG. 1 shows an example flow diagram for automated customer service management, according to an embodiment.

FIG. 2A shows an example vicinity electronic handshaking, according to an embodiment.

FIG. 2B shows another example of electronic handshaking, according to an embodiment.

FIG. 2C shows an example of secret public alert interaction, according to an embodiment.

FIG. 3A shows an example interface for communicating with customer service channels, according to an embodiment.

FIG. 3B shows an example user interface, according to an embodiment.

FIG. 4 shows an example system for providing automated customer service, according to an embodiment.

FIG. 5 shows another example system for providing automated customer service, according to an embodiment.

FIGS. 6A-B show example of interfaces for automated customer service interaction, according to an embodiment.

FIGS. 7A-B show example views on a smart device after vicinity handshaking, according to an embodiment.

FIG. 8 is a high-level block diagram showing an information processing system comprising a computing system, according to an embodiment.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

Customer service (as mentioned in this document), could be part of any business process that involves some form of interaction between customer and the business provider. Customer service could involve representatives of the customer or the business provider taking part in either receiving or providing service or both. The business processes that involve customer service interactions include sales, service, support and more. In retail we can observe them at Point-Of-Sale (POS), customer support and other processes. In hospitality business we observe customer service interactions in most of the processes including but not limited to check-in, check-out and customer support.

Face-to-face customer service remains as a major form of customer service at many business locations irrespective of the other channels of customer service such as phone calls (call center), online chat, and more. While research has shown the importance of face to face communications in customer service, face-to-face service continues to have several limitations, which include one or more below:
(1) Ease of use—Physical location: Face-to-face interactions usually require physically driving to a business location to receive service.
(2) Ease of use—Forced scheduling: Some businesses could restrict their customer to visit only at a predetermined time interval.
(3) Wait times: Customers might have to wait to get service. Sometime customers might stand in a line for an open service-agent to assist the customer.
(4) Different person at different location and at different times: Customers in a business chain with multiple locations will get customer service from different agents at different locations. This takes away any benefits of a long-term face-to-face conversation with a specific person who knows the customer and can personalize everything for the customer.
(5) Different formats of service leads to different service personnel: In most business chains, the people do the face-to-face service and the people who answer of phones or other channels such as email or social media are different. This again, takes away the benefits of approaching a person or the same group of people as the point of contact for a given issue using multiple channels of communication.
(6) Wastage of personnel resources: From an employer perspective, it is difficult to accurately predict the demand for customer service and supply with effective human resources without any loss of resources when customer service is provided face to face.

Consumer service may occur through multiple channels-through phone, email, video calls, text messages, etc. Most importantly, customer service takes place in the traditional route of face-to-face direct interaction. In the near future, it is expected that customer service could also take place through telepresence robots—which are actually humans using a video call to serve the customer from a remote location—we refer to this as “e-porting”. In a few more years, it is expected to have artificial intelligence based customer service to handle some basic customer service interactions that do not necessarily require much intelligence. No matter which channel is used for customer service, or if it is delivered using a real person or artificial intelligence, the objective is customer satisfaction—the “human experience” is the major yardstick.

A Human Experience Management System (HEMS) that manages consumer service requests in one or more multiple channels is provided. Each channel is a potential to satisfy a service request (e.g., Face-to-face interaction by a specific service provider is a channel and a digital video call may be another channel). A service request could be issued directly by the consumer or could be predicted and issued on behalf of the consumer. HEMS provides an illusion (or human experience) of a special “super-heroes service team” that was exclusively created for each customer. Whenever the customer tries to interact with the business using any of the interaction channels, the superhero team answers the service request irrespective of where the customer might be located.

HEMS has information about other entities that take part in this system. This includes the preferences, profile and real-time resource availabilities of the service requestor(s) (the consumers); the preferences, profile and real-time resource availabilities of the business provider(s) (or the businesses); the preferences, profile and real-time resource availabilities of the service provider(s) (or the staff or the professional experts); the compatibility, profile and real-time availabilities of each channel that could be used to manage the human experience. For each service request (or anticipated service request), HEMS determines: the channel of service delivery (e.g., using a real person, or using a phone call or using a video call); the service provider, e.g., which of the staff that are on the inner circle for the service requestor (consumer) that is more apt to take satisfy the service request, given the current information about the multiple channels to provide customer service for the requestor.

In one embodiment, HEMS is provided as a cloud based service or a system hosted in server for one or more businesses. HEMS, tracks all employees, in real time, that can provide customer service; all electronic devices that may be used to provide customer service, the customers that might need service and allocates the proper channel of service based past, present and predicted service request trends.

In another embodiment, HEMS is used in the hospitality industry to form a logical team of hotel-staff in one or more locations as a “service heroes team” who can handle guest (consumer) requests irrespective of the physical location (or the hotel) the guest plans to stay (or is staying). This way guests feel connected to the business as they are served by almost the same group of people whom they have selected to be on their “service heroes' team”. This promotes long-term loyalty to hotels. HEMS uses mobile video calls, and also telepresence apart from scheduling real people who are part of the “service heroes' team” to interact with guests during check-in, check-out and other service requests.

In yet another embodiment, HEMS is offered as a service by a transportation company, such as an airline company (or, other transportation types of organizations, such as trains, busses, cruise lines, etc.) to its customers (especially frequent travelers) to create a personalized logical team (or a “service heroes team”) for each customer. This logical team of people represent the airline (or other transportation organization) to the traveler and members of this logical team receive higher probability of interaction with the customer. In one embodiment, passengers (especially frequent flyers) at airports, airport lounges or at any other place as part of their travel, may be greeted and addressed by this logical team of people who could further their professional acquaintance with the traveler and might be able to assist the traveler in a better way.

In still another embodiment, HEMS is offered as a service by restaurants such as fast-food chains. These restaurants provide their consumers to form a logical team of their employees who'd have a higher probability of interacting with the customer. The employees selected could be from multiple locations of the restaurant. When the consumer is interacting with a franchisee of the restaurant chain through any of the channels of interaction such as face-to-face, or on their drive-through or smart-phone-drive-thru, or phone ordering, the consumer is given an opportunity to interact with an employee (in the consumer's “super hero” team), who might know more about the customer and help the customer even if the employee is at a remote location.

In one embodiment, HEMS is offered as a service at hospitals. Hospitals would have a care team of their employees taking care of a patient. Using HEMS, a patient would have his own logical care team from a medical care group that consists of multiple hospitals. When the patient (e.g., a small child) has to interact with a hospital at a different location, or a different department, HEMS could find out that the child's preferred nurse has some free time at a different location and could have them interact briefly using any of the interaction channels supported by HEMS, such as e-porting using a telepresence robot.

In another embodiment, HEMS is offered as a service by retail chains for its customers. Customers are allowed to form their own personalized logical superhero team of a retail chain's employees (or their associates). When the customer interacts with the business in any of the channels (including physical interaction at the store), HEMS may enable the interaction of the customer with the customer's logical superhero team through any of the interaction channels supported by HEMS. The presence of someone comfortable or known to the customer could help increase sales and also the human experience of the customer.

In yet another embodiment, HEMS could be used to run an exchange of customer services for multiple businesses connecting customer to one or more of their (preferred) superheroes of service. Having an exchange makes it easy for customers to use a single application (or point of contact) for personalized customer service, in addition businesses are able to improve the human experience provided to their consumer across multiple channels in a cost-effective manner.

A new business process and methodology to collect and exchange (share) preferences of customers amongst multiple participating businesses. Process involving employees who observe “kindwords” for each customer, Customer approves each kindword, RBN system maintains the freshness value of each kindword based on customer's past behavior in changing behavior. RBN knows the semantic relationship of the kindwords and matches it with process and location of its origin to determine where it could be used next. RBN uses the preferences for any business in the RBN network to help the customer being treated in personal way.

An electronic system is used to find the preferences of a customer such as machine vision to find out preferences and use them in the RBN.

One or more embodiments provide a system and methods providing and receiving dynamically managed customer service that promotes more “Human Experience (HE)” by combining both the digital and physical worlds of customer service. Our system and methods facilitate long-term customer relationship by giving an option for each customer to form their own logical team of employees (service-agents) who'd serve the customer.

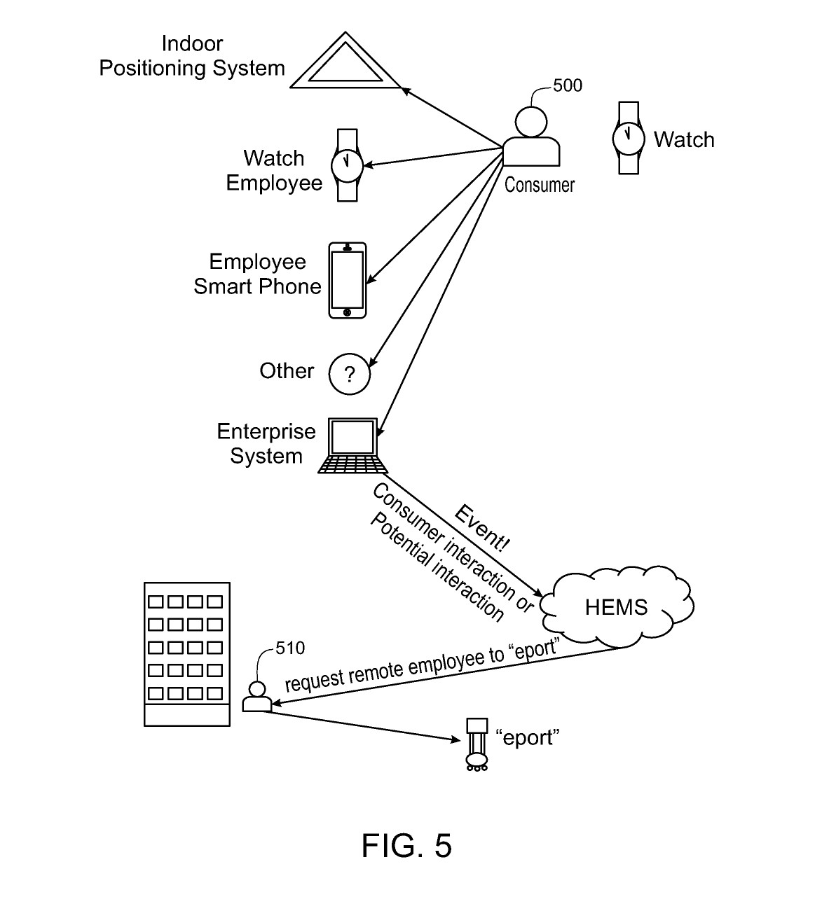

FIG. 4 illustrates a high-level system view for providing automated customer service management, according to one embodiment. The right side of FIG. 4 shows a consumer 400 with his/her electronic devices 410 (e.g., smart phone, camera, content player, video recorder, tablet, wearable device, etc.), a personal computer, a server device, a cloud based server, a smart device (e.g., smart TV, etc.), etc.) that can directly or indirectly send the consumer's location and information such as a unique identification tag to a server (or cloud based server). The left side of FIG. 4 shows how a business may transmit signals that can be used to detect and identify the presence of users of mobile electronic devices in the physical vicinity where consumer service are provided. The physical devices may include, but are not limited to iBeacon, sensors, video cameras, motion-cameras, etc. In one example, these devices also include any form of technology that may be used to identify a person either using their physical attributes, such as facial recognition, using any electronic signals that can be transmitted such as B1uetooth©, NFC or Wi-Fi etc., or unique displayed images (e.g., on a mobile electronic device screen). Different businesses may use different devices that fit into their specific requirements and budget. As shown in FIG. 4, all these signals are sent to the server. In one embodiment, the server also obtains the location and identifies of all employees (and service agents) through their mobile electronic device (e.g., a smartphone, a wearable device, etc.).

In one embodiment, an application (e.g., smartphone app, wearable app, etc.) may be used to provide functionality for obtaining location information. In order to ensure privacy, in one example, the application sends the location and other details only during work hours when the employee (or service agents) could be part of this logical service team. Apart from the devices that send the signals to the server, existing computerized systems that can identify the presence of a specific employee at a work location or a customer at a (Pops) system may also be implemented to provide input to the HEMS server(s). In one example, the HEMS server may also obtain data about the status of all the channels of customer service that it supports for a specific business, such as the working status of the telepresence robots at a location, the number of people in any line waiting for customer service, status of the phone based call center or text-based support. The HEMS server using all these inputs about the preference and availability from the business, customer, service agents and the service channels decides on “who” and “how” a customer interaction may take place for the best possible human experience. The HEMS server informs or prepares the customer, the service agent and any other channel (e.g., the telepresence robot 420 that might be necessary for the customer service interaction).

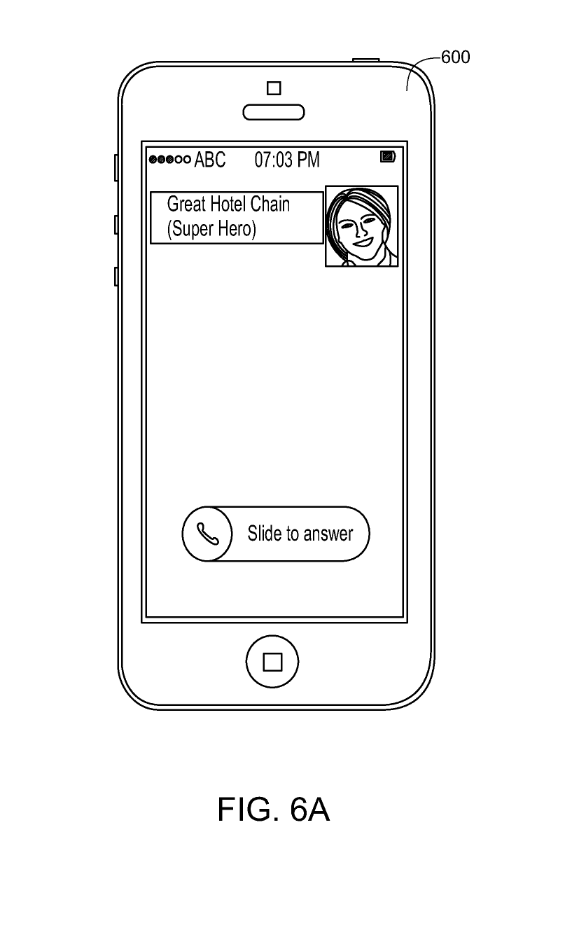

FIG. 5 shows an example system for providing automated customer service, according to one embodiment. In one example, a consumer 500 of a hotel is about to check-in and enter the hotel lobby from its main entrance (or similar location e.g., a mall, airport or any other place where the consumer would need face to face customer service). One or more sensors may send the consumer's location information to the HEMS server. In one example, the customer's own smartphone or wearable device that might have an application to send the customer's location (e.g., using GPS or other location determination processing) to the HEMS server. It may also be that a combination of iBeacons and other similar sensors at the hotel entrance along with the consumer's smartphone or wearable devices that inform the HEMS server about the consumer's location.

In one embodiment, the HEMS server determines the potential consumer interaction between the consumer and the business at that location. The HEMS server then predicts what would be the best human experience from the perspective of the customer at that point, given his/her preferences (e.g., from a user profile, obtained from learning history of past consumer actions, purchases, requests, etc.). HEMS also considers the business rules that might be in place of that specific customer (e.g., at the entrance location for a guest with platinum elite status or any other particular status or tier that is associated with rules for provided services or level of service) that is arriving for a potential check-in, bring in a personal service agent (in the superhero team of the guest) to welcome the consumer at the lobby. The HEMS server finds a member of the service agents for that consumer that is free for the next several minutes at a different location of the hotel chain (e.g., by processing a comparison of available service agents, current assigned tasks, location, schedule, etc.). It also determines if there is a telepresence robot available for use at the location where the customer is expected to check-in. The HEMS server sends a signal requesting the remote service agent 510 to “e-port” using the telepresence robot and welcomes the consumer who is checking-in at the hotel as a guest. In another embodiment, the HEMS server may request more than one consumer agent to attend to the same guest just to ensure that even if one person could not make it, someone else could. In such a case, the consumer agents who get the request from HEMS would have the multiple options, including:
Dedicated Commit (meaning the consumer agent is confident that he should be able to honor the request from HEMS)
Commit with call for backup (meaning the consumer agent will make all efforts to attend to the request from HEMS, but is not sure if he/she might be able to make it on time)
Snooze or no action (meaning HEMS did not obtain any valid responses and the consumer agent is either not able to answer whether they can honor the request made by HEMS)
Not possible at this time

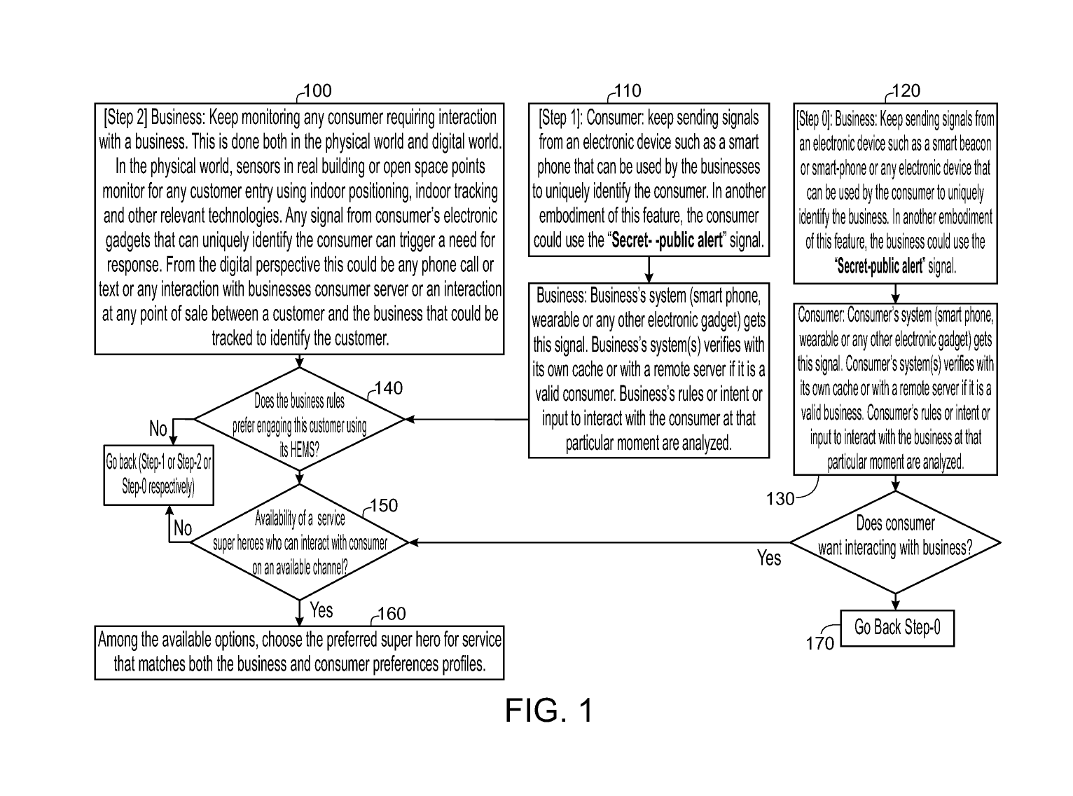

HEMS would use these responses from the service agents in making sure the guest (consumer) receives a better human experience from one or more service agents based on the business policies. For example, a high-end business might place more weightage on the customer getting served (or interacting) by his/her preferred customer-service-agent even if it means the customer-agent might be simply waiting for a customer for some time. Business policies, apart from trade-offs on how the customer agent's time is spent, could also include how many customer agents could be engaged for customer interaction at any given time, the prioritization or categorization of customers and what type of services they enjoy. HEMS also provides multiple service protocols for service agents to fully commit or to remain as a potential candidate at the last minute. In one example, HEMS would take care of scheduling service agents in a way to enforce the business policy on matching the customer's expectations and also without wasting the service agent's time in waiting for customer interactions. HEMS would use multiple scheduling policies (algorithms) to match with each business use case to deliver a cost-effective human experience that delights both the customer and the business that provides the customer service (FIG. 1, which shows an example flow diagram for automated customer service management with multiple stages 100, 110, 120, 130 140, 150, 160 and 170). Some of the HEMS approaches for scheduling of service agents include but are not limited to:
Simple first-come-first-serve basis: The first agent who responds with his availability to serve in a “heroes team” (HT) of customer, becomes the person to serve.
Priority-class queuing: In this approach the available set of customer agents are divided into multiple buckets based on their preference (ratings) by customers. The customers are also divided into buckets based on their priority to business. A late binding of service-agent to a customer is made. When a customer-agent is required, the customer's class from the top (in terms of the business's priority) is first determined. A similar class from the top for the customer-agent is used to determine the right bucket of the customer-agent. (e.g., Category A (top priority) customers get category A customer service agents).
Quorum based on probability of each agent serving the customer: In this approach, again late-binding of the customer agent is used. In the last N minutes (say 5 or 10 minutes) before the service or customer interaction is required, a computer generated logical quorum of potential service agents from the customer's HT is created. All customer service agents who think they can attend the request respond yes electronically. The computer calculates the minimum number of people who need to be in the quorum so that at least one of them would be able to make it and serve the customer. The computer uses past responses and future workloads.

A “service super heroes team” is a logical team of people created to provide personalized customer service from a business that allows its customers to individually select any employee from its business to provide customer service irrespective of the barriers created by geo-location or the channel of customer service. Allowing customers to decide who gets to serve them is a great advantage for the customer, the business and also the employee (or business associate) as provided below. Advantages are described below to assist in understanding the relevant processes according to one or more embodiments:

Example advantages for a customer:
1. Highly personalized contact points that understand and speak the language of the customer both literally and metaphorically.
2. Customer is empowered to modify and act if s/he needs any change in her/his own “service super heroes team” (HT).
3. A greater and direct customer-service person relationship is created between the customer and service person.
4. Customer has an option to personalize their service-agents not only based on personal interaction but also based on other criteria (e.g., a customer at a newborn chain store with a young baby might prefer having a lactating mother provide personalized customer service).

Advantages for Businesses:
1. Maintaining higher levels of customer satisfaction to predict and help the customer to talk to the right person.
2. Business can use data analytics to easily understand the demographics of agents they need to hire and/or train more for each customer market segment.
3. Business does not have to take the sole moral responsibility for generating better “human experiences”—the customer also had responsibility in choosing an agent as his/her point of contact for the business.

Advantages for Service-Agents:
1. Recognition for hard work and care. Rather than customer giving rating for the business alone, customers appreciate the person who really cared and provided service. This gives them recognition and the ability to show their value to their current and future employers.
2. Service-agents also may have a way to say their preferred type of customers and customers that they prefer to send to other agents based on their prior personal experiences.
3. The service agents in large-chains could make additional income by servicing at other locations or franchises.
4. Service agents could receive tips to improve prompt service using this system.

In one embodiment, the following provides an example process for the creation and maintenance for a HT (heroes' team). It should be noted that the processing order may be rearranged and may be understood by professionals that for creating information and data management systems for multi-site businesses:
1) Maintain a database or information about each individual employee that must be participating in this system.
   a) Allow employee to authenticate and update certain sections of their profile so that customers may spot the employee and add them to their HT.
   b) Allow employees to connect multiple profiles from different workplaces into one (e.g., if possible based on rules, policies, etc.).
   c) Connect with the employee work-hours or scheduling systems and/or provide updating whenever the employee is free to attend to customers as part of a HT system.
   d) Additionally have information on what channels of consumer-service does this agent have access to, and the channels the employee is comfortable in using to provide customer service.
2) Maintain a database or information about each customer (or customer groups like a family or a group of friends) visiting the business
   a) Provide a personalized HT based on one or more business-oriented rules and heuristics, or simply based on where the user is expected to be often.
   b) Allow each consumer to update their own HT and provide several criteria for selecting their HT dynamically.
   c) Allow each consumer to update their ratings for each employee (e.g., through a profile, a user-interface, website, etc.).
3) Maintain or connect to a database including the business information, its rules in handling different classes (e.g., levels of service) of customers and connect it to a HEMS system.
4) Maintain or connect to a database including Human Experience related tools and gadgets (e.g., availability of Telepresence robots, Status of Smartphones and wearables used by service-agents).

In addition to having a database of telepresence robots, the HEMS system also maintains a scheduling system for telepresence robots. Each business location may have only few telepresence robots, and these robots are used by customer service agents for e-porting and interacting with remote customers. The availability of these robots may also determine whether the next customer can be served by another robot or that a real person has to be used. In one embodiment, the availability and scheduling of these robots are managed as follows:
1. Maintain an active list in the database with the status of each robot (e.g., the robots are available, the robots are being used, the robots are temporarily not available due to repair, etc.).
2. A list of potential reservations may be kept for each robot. These robot reservations may be indexed by time and by a unique identification of the robot for faster access during scheduling lookups.
3. The database also maintains the features supported by each robot (e.g., a touch screen, credit-card support, ability to dispatch electronic or magnetic-stripe cards, NFC etc.).
4. When a new customer service interaction is to be scheduled in real-time, the choice between using a real-person (local) or a remote-person (virtual) has to be made.
5. For a given physical business location, let T=time epoch interval for which scheduling has to be made (e.g., next 10 minutes). Let #Dr=Demand estimated in the next epoch for a remote service that involves usage of a telepresence robot. #Dp=Estimated demand for in-person service. #Tr=Threshold or minimum number of telepresence robots that has to be reserved at any time for a VIP customer in that particular location. Similarly, #Tp=Minimum threshold of real people who need to be free (reserved) at any time for any VIP customer. Let #Ar=Number of available telepresence robots and #Ap=Number of people at the physical business location to help customers exclusively for this given task.
6. In one embodiment, the scheduling of the telepresence is simply based on availability. Any request to use a robot is accepted as long as the resource is available—no checks on priority are considered. This approach can be used for any queuing system for telepresence robots that multiple agents need to use for e-porting. In another embodiment, it is first determined if the customer is a VIP customer.
   6.1. If the customer is a VIP customer,
      6.1.1. If #Ap and #Ar>0; If VIP customer prefers any available remote-agent over a local in-person agent, the remote agent and a telepresence robot are scheduled. Otherwise a local person is scheduled.
      6.1.2. If #Ap or #Ar=0; The available person serving as the agent (remote or local) is used to serve the VIP customer.
      6.1.3. If both #Ap and #Ar=0; a VIP-wait state is flagged.
   6.2. If the customer is not a VIP customer
      6.2.1. If (#Ap-#Tp)>0 and (#Ap-#Tp)>0; The customer's preferences of available agents are used to determine the mode of service.
      6.2.2. If (#Ap-#Tp)<=0 OR (#Ap-#Tp)<=0; Any available person acting as an agent is used (remote or local person) for service.
      6.2.3. If (#Ap-#Tp)<=0 and (#Ap-#Tp)<=0; a wait state is flagged.
7. The status of the telepresence robot and/or the people involved are updated as busy until their interaction is complete.

HEMS enables people to seamlessly migrate their customer service interactions from the digital world to the physical world and vice versa. When customers 400 arrive at a physical business location, their “super service heroes team” needs to know about their target customer's presence or arrival at the physical location (as mentioned in FIG. 4) so that the super heroes team can serve the customer better. At the same time, the target customer must not sacrifice his/her privacy when trying to “digitally announce” their physical presence at a location. One example provides a customer and a service agent to identify and authenticate each other at a business location (or any location) where there may be many other people before initiating any customer service. One or more embodiments provide the following methods to digitally announce and confirm readiness for consumer interaction when the parties are close to each other:
1) Human Experience vicinity handshake
2) “I am here” call

In the first approach, one embodiment uses the “vicinity handshake” that may be used by HEMS (or any other system) to introduce two people for a face-to-face interaction (in physical world) using their smartphone or wearable device after validating both parties without compromising their privacy in a public setting.

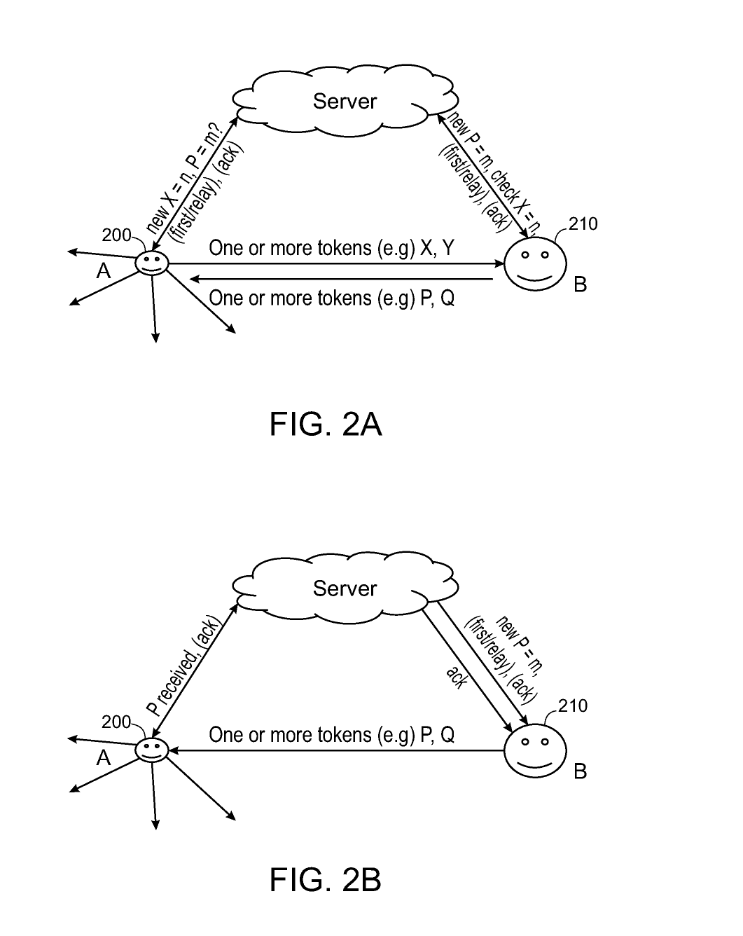

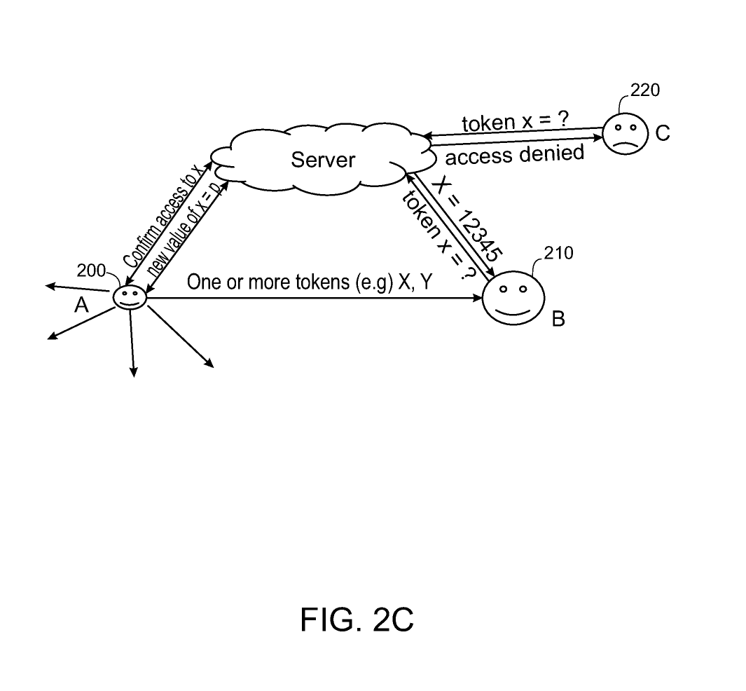

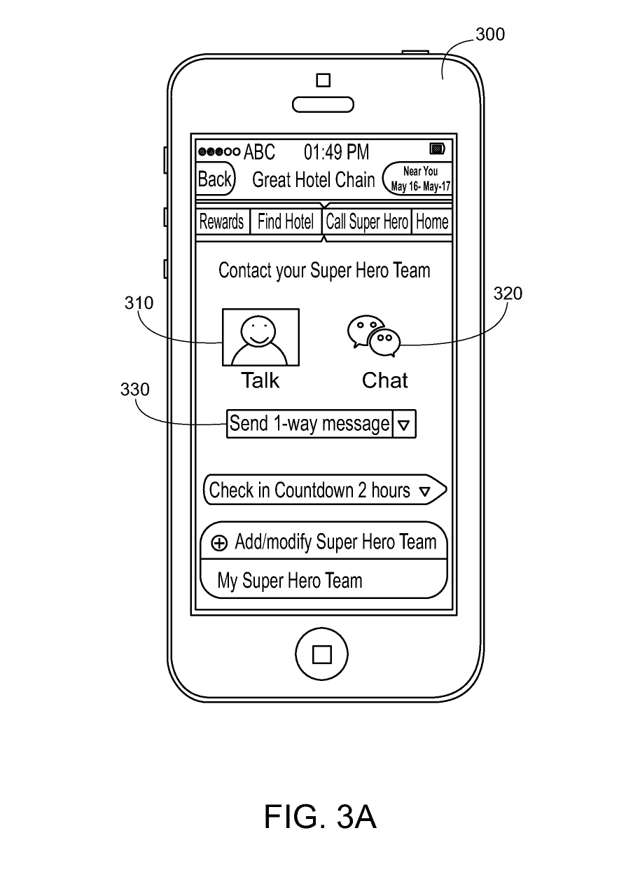

FIG. 2A shows an example of vicinity electronic handshaking, according to an embodiment. The vicinity handshake is executed by two users (e.g., a consumer and a service agent) on their smartphone, mobile electronic device or wearable device. We consider the two parties as A 200 and B 210 in FIG. 2A, represented as smiley faces that are physically close to each other. Both users will use this method in a place where there are a lot of people to identify each other, (e.g., a hotel lobby or the arrival area in an airport), and both the service agent and customer need to identify themselves to each other. In the embodiment illustrated in FIG. 2A, the HEMS server (or any other system) sends a value to the both A 200 and B 210. The values sent from the server are represented as X and P. X is the value sent to A and P is the value sent to B. Both X and P may be considered as a set of codes (e.g., numbers and/or characters that make up a random set of characters). In addition to the value of these authentication sets, the server also sends information on what A and B must do in order to complete the handshake as a “first/relay”. “First/relay” provides information as to whether A 200 or B 210 should initiate the handshake first with the other party. The method or protocol (or algorithm) includes the following data transfers and acknowledgements—the order of these are not important (hence these are not numbered):
The server may randomly choose any of the two to start the handshake first.
The first one (e.g., A 200 in FIG. 2A), sends its new information X to B 210.
B 210, upon receipt of A's value checks if it matches with the value it received from the server. If it does match, there are two possible actions:
   [optional step] B 210 sends an acknowledgement to the server that it confirmed the value for A 200
   B 210 sends its new value for P to A 200
A 200, upon receipt of B's value checks if it matches with the value it got from the server. If it does match there are two possible actions:
   [optional step] A sends an acknowledgement to the server that it confirmed the value for A 200
   B 210 starts the customer-interaction process that A 200 & B 210 were about to start.

It is noted that the interaction between A 200 and B 210 may be implemented on top of any other protocol, such as Low-power B1uetooth® for transport of data. The “vicinity handshake” is independent of the transport protocol. The vicinity handshake may be implemented by any applicable protocol or enhancement in NFC. When used with Low-power Bluetooth®, such as the iBeacon standard as the transport, the payload may contain the data that is being transferred. For example, iBeacon's UUID, major and minor fields can be used to transmit this data. Normally an iBeacon (device) is used to transmit the iBeacon signals and these iBeacon devices are just transmitters and cannot receive any iBeacon signals. In one embodiment, the processing for a “vicinity handshake” assumes a device can both send and receive iBeacon communication. Smartphones may be used for both sending and receiving iBeacon transmitters and act as both advertiser (transmitter) and client. In our approach, each smartphone takes turns on acting as be transmitter.

Other implementation details that would be evident for these data and acknowledgement transfers:
Message transfers could take place in any order (e.g., if prior-authentication and information is shared and cached, the need to transfer them again is not required).
Each of the messages may be implemented as a single message or as multiple messages to transfer the same information between any of the two parties mentioned.
Bi-directional arrows for messages indicate message transfers between the two parties where in the required objective of data or acknowledgement transfers achieved.

As seen in FIG. 2A and the explanation above, one embodiment establishes a credible identity of both entities to use a “shared secret” between A 200 and B 210. In FIG. 2A, the intermediary HEMS server is used to create the shared secret and send it to both A and B. This avoids anyone trying to pretend they are A 200 or B 210. In another embodiment, if A 200 or B 210 had some other way to communicate on a trusted channel (apart from the intermediary server), one of them may create a shared secret and share it using that channel. Once A 200 and B 210 have established the shared-secret and are at a physical location where a trusted channel is not available, they can use the open near field communication to do data transfers just between A 200 and B 210 alone that are shown in FIG. 2A.

In one embodiment, A 200 and B 210 may have communicated offline if they already had the shared-secret, which is useful in scenarios where either A or B might not have access to the trusted channel. An example of the scenario is an international traveler going to another country where he/she does not have smartphone signal reception or interne connectivity, and needs to identify and validate the person claiming to be his taxi (or other type of transportation) driver at the airport upon arrival.

The critical messages for data transfer between A 200 and B 210 in FIG. 2A uses an ad-hoc and proximity based network, such as using the B1uetooth® to advertise and communicate with close by devices. In another embodiment, for the “vicinity handshake” the number of messages for data sharing through proximity-based network may be reduced as shown in FIG. 2B (showing another hand shaking example). In FIG. 2B instead of having the shared secret exchanged and verified by the participating smartphone or wearable devices, a closed loop is created. Unlike the example in FIG. 2A, in FIG. 2B there is only one data transfer message. Hence in case of B1uetooth®, only one device has to act as the transmitter. The data exchange (or the core messages) is still very similar with the example shown in FIG. 2A and is described as follows:
The server randomly chooses any of the two (A 200 or B 210) to start the handshake first.
The first one (e.g., B 210) is selected. In this case, the server has to send a “shared secret” only to the selected one (and not to both A 200 and B 210).
B 210 sends its new value for P to A 200.
A 200, upon receipt of B's value, validates the value of P with the server.
The server, upon receipt of P from A 200, validates P for a match with the original value of P that it sent for this specific interaction.
   If there is a match and P is valid:
      Server sends an acknowledgement to A 200 that “B” is authenticated and is identified.
      Server also sends an acknowledgement to B 210 that A 200 is also authenticated and is identified correctly (after doing the server's own authentication process with A).
   If there is no match
      Server checks if A 200 is a legitimate user of its system
         If yes, server sends an alert acknowledging that it has aborted any potential interaction.
         Else server ignores.
      Server also checks if B 210 is a legitimate user of its system
         If yes, server sends an alert acknowledging that it has aborted any potential interaction (or the threat)
         Else server ignores.

The “vicinity handshake” may obtain two or more parties to identify and authenticate themselves based on technologies that work with proximity and ad-hoc networking. While the examples provided in FIGS. 2A-B focus on only two parties A and B, multiple parties may be involved in both scenarios shown in FIGS. 2A-B. In one example, implementations may be customized. When more than one party is involved, the “shared secret” exchange and authentication with the server (or by themselves) has to take place between all parties that are not already authenticated for trust.

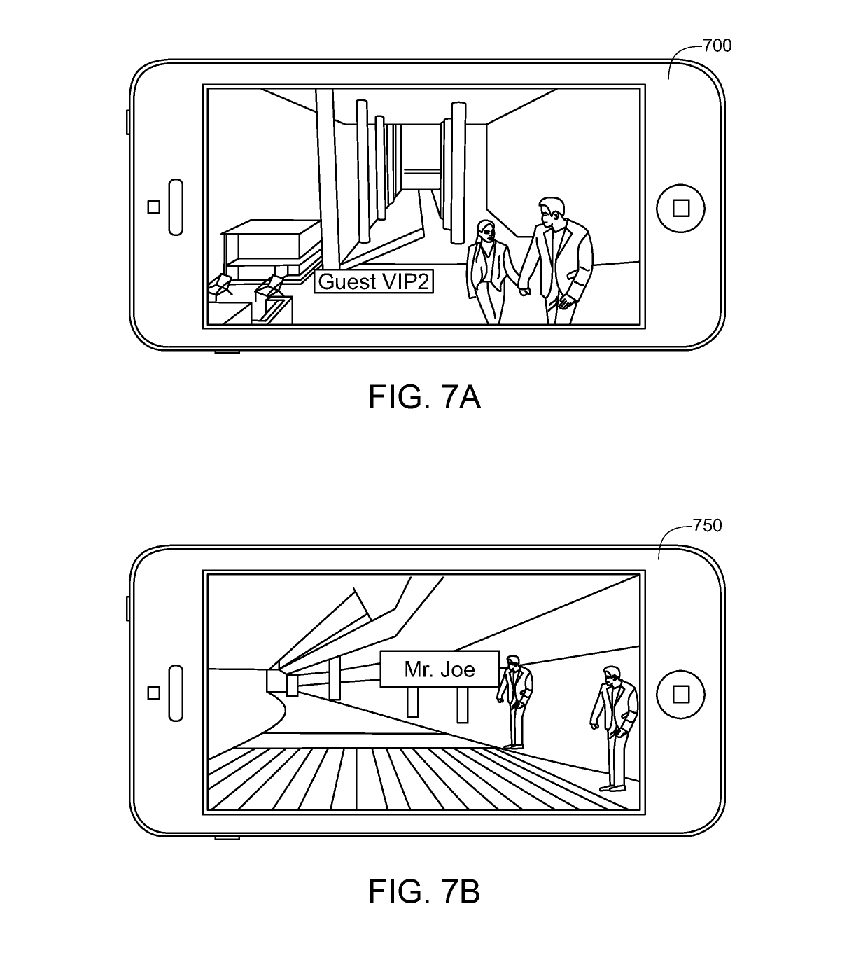

An extension of the “vicinity handshake” is “vicinity view”. Once the handshake is established, a “vicinity view” may be created by showing people (or objects) in the immediate proximity with whom a “vicinity handshake” has been carried out recently. This could be made as an augmented view with video or picture of the real background over which the known people may be marked as shown in FIGS. 7A-B (showing example views on a smart device after vicinity handshaking). After the vicinity handshake is done with their customers, the phone of a taxicab (or other transportation carrier) driver or a hotel service agent could predict their customer's location and may be used on this map. The taxi cab driver or the hotel service agent may have some more ibeacons apart from their own smartphone, which may improve the accuracy of the vicinity view.

The second form of digital identification that is presented is “I am here” call. The “vicinity view” created using “vicinity handshake” are useful in both identifying and authenticating two or more parties for customer service and other use cases. In addition, we have scenarios where an instant interaction is required between the customer and the service agent. We use “I am here” call for these scenarios. Example use cases include a superhero service agent looking for his target guest in a hotel lobby 700, or a passenger 750 looking for his taxi (or other transportation carrier) driver to notify where he/she is waiting. It is assumed that the caller and the recipient are both using an application on their smartphone or wearable device to make the call.

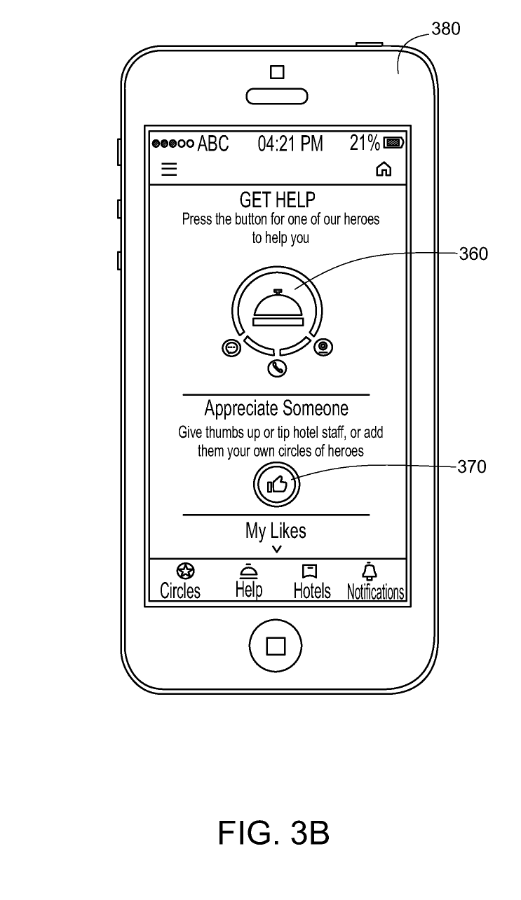

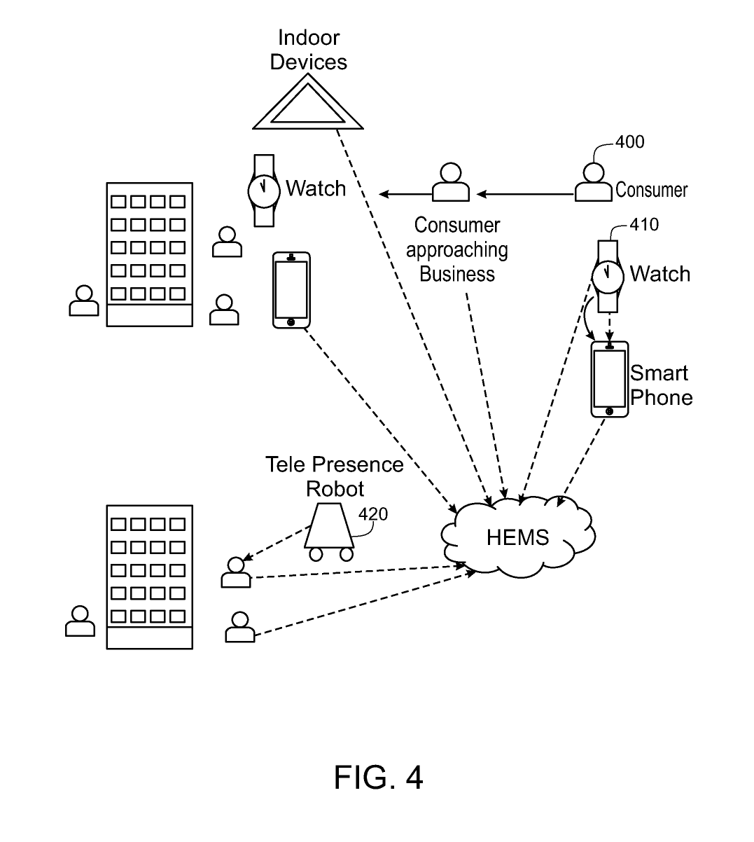

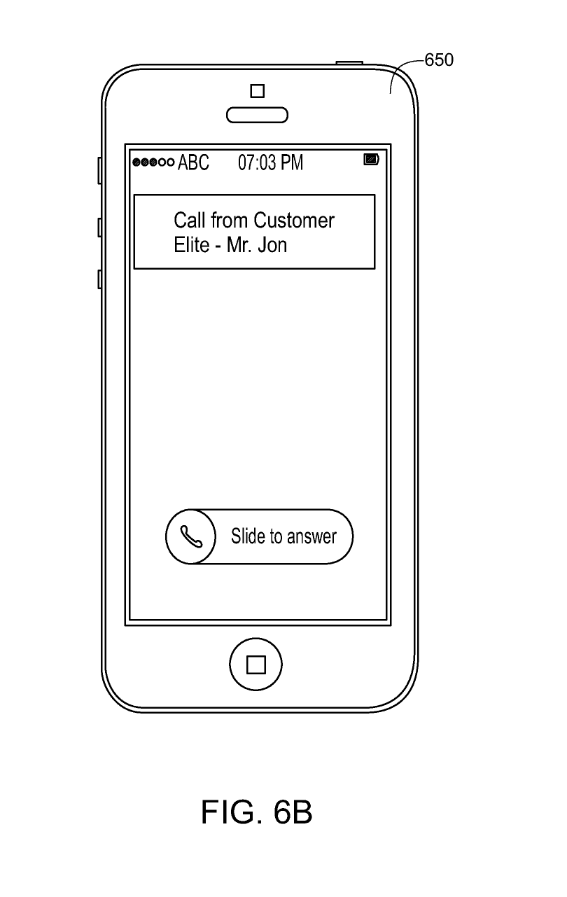

FIG. 3B shows another example interface 380, according to one embodiment. In order to enforce privacy, the numbers of both the caller and recipient can be masked by the server, so both of them think they are calling a dummy number. In one embodiment, the “I am here” call processing is as follows:
1) The caller is provided with a link, a call button 360 or other provided feature (e.g., such as particular speech command or gesture using the smartphone or wearable) provided in/by a user interface using an app. on a mobile device. The link, button shown does not provide any information about the recipient's real phone number. In an alternate embodiment, this call could be automatically triggered if the HEMS system figures out the customer needs some help from a customer service agent.
2) [Optional] When the caller clicks on it, the caller is provided with a message that the caller would receive an “I am here” call connecting the caller (him/herself) with the recipient. The caller is also shown his/her number from his profile on which he/she would be called back. The caller has the option to show his/her profile picture or a new picture to the recipient so that it is easier for the recipient to identify the caller when they meet (usually in the next few minutes as part of their customer service interaction).
3) If the caller agrees to place the call, we move to the next step, else exit.
4) A message is sent by the application to the server that the caller wants to be on a call with the recipient.
5) The server checks for access rights. The business that is providing this service could have its own local or global restrictions on who can call and at what times.
6) If the server finds that the caller has access rights, we move on to the next step. Else exit this procedure.
7) The server sends a message to the recipient's smartphone application(s) with a phone number, picture and a name that would be most appropriate to appear (e.g., Hotel service—Mark, or the driver—Joe.
   a) In another embodiment, this step could be pre-processed by the server expecting a potential call. In which case the server could request a specific hash value (or a code) to confirm the application has the updated information. Move to step 9a.
   b) Also in another embodiment, the picture could be changed a little bit by the server (e.g., the face could be masked a bit to preserve the privacy of the caller) (FIG. 6B showing an example of an interface 650 for automated customer service interaction with only the caller name that the customer has decided to be used in public).
8) The recipient's application saves the caller's contact information with picture on the recipient's device. If the contact number is already present with a different name (most likely), it is updated—else a new one is created.
9) The recipient sends an acknowledgement to the server that it is ready and has saved the contact information.
   a) Optionally in one or more implementations, the application may send the server a hash value representing all the current information to confirm the data on the application is up to date.
   b) Optionally in other implementations, if this process is taking a while, the server would skip waiting for recipient and directly move to step 10. This is done so that the caller does not have to keep waiting for a long time.
10) Is the hash-code or confirmation from recipient correct?
   a) If yes, make a call to both recipient and caller so that they can talk to each other. The call interface for customer 600 and agent 650 will appear as shown in FIGS. 6A-B respectively.

The ability to change channels during a cluster interaction is also necessary and useful. For example, a guest might be invited to a hotel lobby by a service agent from the hotel as part of the guest's HT. However, the guest might be shown around by a telepresence robot operated by another person who might be in the superhero team in a different location. This requires scheduling the service agent physically present at the hotel and the scheduling of the remote person and that of the telepresence robot also. The guest would have a chance to interact with the person on the telepresence robot from their smartphone app.

FIG. 3A shows an example interface 300 for communicating with customer service channels, according to one embodiment. Multiple channels of communication evolve in the HEMS paradigm by adding more personalized human experience and feedback in each customer service interactions. In one example, each customer interaction using any channel including face-to-face may be rated by the customer (if they prefer). After each phone call or telepresence e-porting or face-to-face interaction the smartphone or wearable application for the customer would automatically bring up the screen to rate the customer service agent 370. Since the HT is digitally connected with the customer, normal calls and other processes also get changed (e.g., “Digitally interactive call/text).

A “Digitally interactive call/text” on smartphones provide a better human experience together with HT or even without HT:
1) A customer calls or texts a customer service number (e.g., call or text 1800-help from a smart device) (smartphone, wearable or from any computer-like device such a new Ethernet-enabled office phones or a real computer itself)
2) The app (or software that comes with the phone operating system) on the smartphone compares if the number being called is a predefined customer service number. This could be done either locally on the phone itself OR through a cloud based service
3) if the number is a predefined customer service number
   a) A digital interface is provided on the phone (or the device) which could show the name of the business the user is calling.
   b) The app sends a message to the HEMS server with data that could help the HEMS serve identify the customer. (e.g., phone number or customer-id that could be encrypted).
   c) The HEMS server could send back a personalized digital interface specific to the customer based on the geo-location, time, and other contexts such as prior recent interactions by the customer (e.g., the digital interface could show that the customer has an upcoming hotel reservation for his/her recent trip and could ask if he/she needed any help on that).
   d) The digital interface provides options to expedite the call before the customer talks to a real person. Examples of the options that are used to interact with the customer (caller) include but are not limited to:
      i) Allow the customer to type in a question
      ii) Show a drop down box or button to select the reason for the call/text
      iii) A selection on how the call/text has to be routed
   e) The customer service agent could be connected based on the input provided by the customer to the digital interface. A member of HT or a regular customer service agent would attend the call 310 or text 320, 330.
   f) During the call or text with the customer service agent, the customer could be provided with other context menus over the app dynamically to help with the interaction. The call or text could be converted to a video call or any other channel of customer interaction.
   g) Go to step 5
4) On the other hand, If the number is not a predefined number on the list of HEMS server
   a) Normal call or text interaction takes place. After the call, an optional rating interface could be provided to rate the human experience and contentment of the customer.

A method and service that may provide HEMS for multiple businesses as an exchange by combining and amortizing the operations for multiple businesses; and also for enabling and allowing cross pollination of customer-service across multiple business that benefits everyone including the customer.

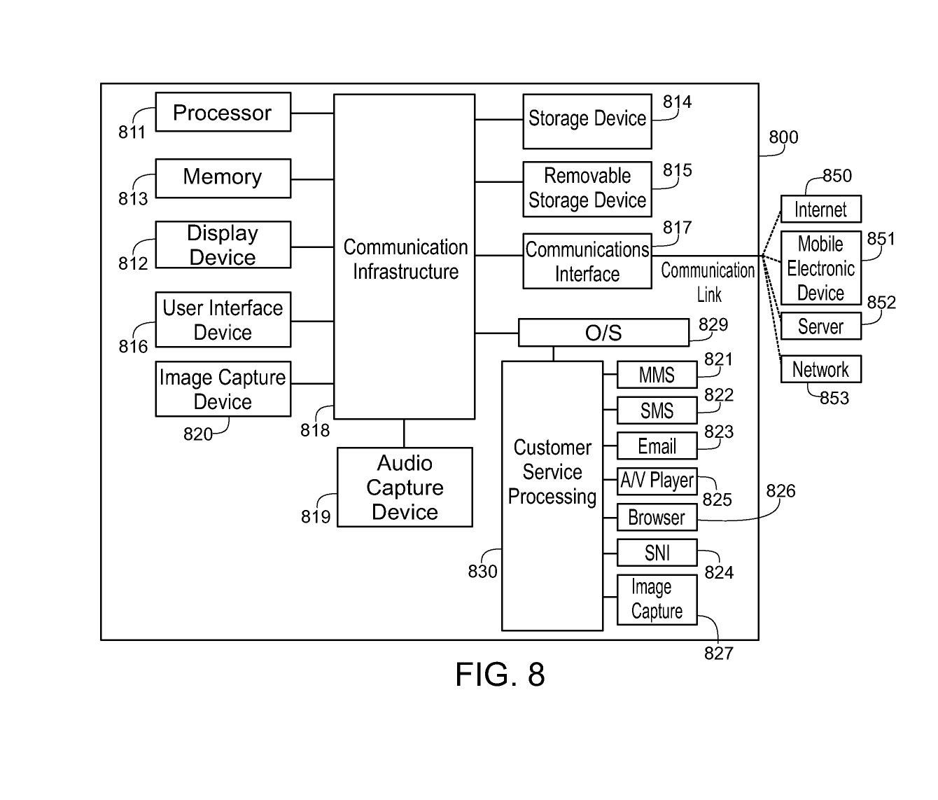

FIG. 8 is a high-level block diagram showing an information processing system comprising a computing system 800 implementing one or more embodiments. The system 800 includes one or more processors 811 (e.g., ASIC, CPU, etc.), and may further include an electronic display device 812 (for displaying graphics, text, and other data), a main memory 813 (e.g., random access memory (RAM), cache devices, etc.), storage device 814 (e.g., hard disk drive), removable storage device 815 (e.g., removable storage drive, removable memory, a magnetic tape drive, optical disk drive, computer-readable medium having stored therein computer software and/or data), user interface device 816 (e.g., keyboard, touch screen, keypad, pointing device), and a communication interface 817 (e.g., modem, wireless transceiver (such as Wi-Fi, Cellular), a network interface (such as an Ethernet card), a communications port, or a PCMCIA slot and card).

The communication interface 817 allows software and data to be transferred between the computer system and external devices through the Internet 850, mobile electronic device 851, a server 852, a network 853, etc. The system 800 further includes a communications infrastructure 818 (e.g., a communications bus, cross bar, or network) to which the aforementioned devices/interfaces 811 through 817 are connected.

The information transferred via communications interface 817 may be in the form of signals such as electronic, electromagnetic, optical, or other signals capable of being received by communications interface 817, via a communication link that carries signals and may be implemented using wire or cable, fiber optics, a phone line, a cellular phone link, an radio frequency (RF) link, and/or other communication channels.

In one implementation of one or more embodiments in a mobile wireless device (e.g., a mobile phone, smartphone, tablet, mobile computing device, wearable device, etc.), the system 800 further includes an image capture device 820, such as a camera), and an audio capture device 819, such as a microphone). The system 800 may further include application interfaces as MMS interface 821, SMS interface 822, email interface 823, social network interface (SNI) 824, audio/video (AV) player 825, web browser 826, image capture interface 827, etc.

In one embodiment, the system 800 includes decoding processing interface 830 that may implement automated customer service features of FIG. 4) and processing similar as described above. In one embodiment, the customer service processing interface 830 along with an operating system 829 may be implemented as executable code residing in a memory of the system 800. In another embodiment, the customer service processing interface 830 may be provided in hardware, firmware, etc.

Collection and Reverse Brokering of Customer Preferences

An important part of any customer services platform, where customer experience is a key success metric of success in the business, is the part that deals with customer preferences. Customer preferences could include a wide variety of topics for each business. Any customer facing business (such as hotels, restaurants, airlines, retail chains) need to know details about customer's preference about each business process to be carried out that will impact the customer experience (e.g) will the customer prefer to check-in with a friendly smile and personalized attention of a human being OR will the customer prefer to use a kiosk.

The approaches available today to capture customer preferences at a business location are either inaccurate, using statistics that use a probability of a generic population to match a require critera, or they require the customer to take effort to mention their preferences for everything. Not all customers want to manually enter their preferences for every activity in a questionnaire or interview.

We introduce the “Reverse Brokering Network” (RBN) as a methodology to solve this problem of how to collect customer preferences about each customer and also how to use them at the right time for each business interaction or touchpoint.

1) In our approach, multiple business locations B1, B2, B3 share a common network (database) in which they exchange preferences of their customers. Each time a customer C1 visits a business B1, an employee (E1) of B1 could notice any specific preferences (P1 . . . Pn) of the Customer C1.
2) Employee E1, then records simple key words to capture each of the preferences P1. . . Pn. Some embodiments of RBN would restrict how many “key words” and employee could enter in the system for a given time period. These “key words” describe the unique preferences. They are also called “Kind words”, as the employee wants to be kind to the customer and help the customer to get the personalized attention anywhere they go. For example E1 might record something like “breakfast orange juice” at a fast food or a restaurant.
3) Customer C1 gets informed that than employee E1 has used some “Kind words” to help them get their prefered service. Customer C1 can now accept the kindwords to their profile. Customer C1 could also determine access levels to these kindworlds based on several criteria.
4) In some cases of RBN, once C1 accepts the kindwords from E1, E1 could could get some incentives to encourage the behaviour.
5) The RBN's natrual lanaguage parsing systems analyses what that keyword is all about for the customer. RBN has information about employee's location, when then kindword was submitted. It also knows if any business process was associated with that kindword. In our example the RBN system finds our “breakfast orange juice” to mean that customer prefers orange at breakfast
6) Once a kind-word has been made as a fact (confirmed relatively recently by the customer) it could be used by the system. B1's privileges within the RBN and the RBN policies control how the kindwords generated are used. They could be shared all across over RBN with multiple businesses from different industries at the right time.
7) When customer C1 visits a another business, say a hotel or a airline or even a high-end retail store in the morning where a breakfast is provided, the RBN would be able to do a “predictive and personalized service” in amending the business process specific to C1 and suggest they can they can provide C1's favorite preference (P1) . . . orange juice.
8) Kindwords deteriorate their factual value over time. The RBN keeps the freshness value for each customer based on their patterns. It knows some customers have some habitual habits and some keep changing.
9) The exchange of kindwords as facts in the RBN is based on the RBN's membership policies and each business's level of membership in the RBN.

In one embodiment of the RBN, instead of an employee E1 finding a preference P1, an automated system with machine vision would find P1 and submit to the RBN. (e.g) A retail store finds out a customer C1 is more interested in blue jeans.

As is known to those skilled in the art, the aforementioned example architectures described above, according to said architectures, can be implemented in many ways, such as program instructions for execution by a processor, as software modules, microcode, as computer program product on computer readable media, as analog/logic circuits, as application specific integrated circuits, as firmware, as consumer electronic devices, AV devices, wireless/wired transmitters, wireless/wired receivers, networks, multi-media devices, etc. Further, embodiments of said Architecture can take the form of an entirely hardware embodiment, an entirely software embodiment or an embodiment containing both hardware and software elements.

One or more embodiments have been described with reference to flowchart illustrations and/or block diagrams of methods, apparatus (systems) and computer program products according to one or more embodiments. Each block of such illustrations/diagrams, or combinations thereof, can be implemented by computer program instructions. The computer program instructions when provided to a processor produce a machine, such that the instructions, which execute via the processor create means for implementing the functions/operations specified in the flowchart and/or block diagram. Each block in the flowchart/block diagrams may represent a hardware and/or software module or logic, implementing one or more embodiments. In alternative implementations, the functions noted in the blocks may occur out of the order noted in the figures, concurrently, etc.

The terms “computer program medium,” “computer usable medium,” “computer readable medium”, and “computer program product,” are used to generally refer to media such as main memory, secondary memory, removable storage drive, a hard disk installed in hard disk drive. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Computer program instructions representing the block diagram and/or flowcharts herein may be loaded onto a computer, programmable data processing apparatus, or processing devices to cause a series of operations performed thereon to produce a computer implemented process. Computer programs (i.e., computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system. A computer program product comprises a tangible storage medium readable by a computer system and storing instructions for execution by the computer system for performing a method of one or more embodiments.

Though the embodiments have been described with reference to certain versions thereof; however, other versions are possible. Therefore, the spirit and scope of the appended claims should not be limited to the description of the preferred versions contained herein.

What is claimed is:

1. A method comprising:
issuing a customer service request for a mobile electronic device;
obtaining customer preferences for the issued customer service request;
dynamically determining a match between the obtained customer preferences with at least one of a business preference and rules;
dynamically monitoring signals provided by the mobile electronic device and electronic devices in a venue to determine one or more patterns for the mobile electronic device; and
assigning at least one service communication channel and a service provider for the customer service request to provide interaction between the service provider and the mobile electronic device based on the match, the one or more patterns and service provider availability.

2. The method of claim 1, wherein:
the service provider availability is determined based on interfacing with one or more scheduling applications; and
the service provider is at least one of: located in the venue, remotely located to the venue, and is a virtual service provider representative.

3. The method of claim 1, wherein the issued customer service request is initiated by at least one of: a vicinity handshake with the mobile electronic device, a vicinity view determination, receiving initiation from the mobile electronic device and an automatic issuance received by the mobile electronic device.

4. The method of claim 1, wherein the customer preferences comprise selection of preferences for at least one of: type of service communication channel, types of customer service providers and particular customer service providers.

5. The method of claim 4, wherein the type of service communication channel comprises:
an in person service communication channel, an audio based service communication channel using the mobile electronic device, a text message based service communication channel, or a video based service communication channel using the mobile electronic device.

6. The method of claim 1, wherein the business preference and rules are based on at least one of: general policies, customer specific policies, based on customer selected billing preferences and interaction time limits.

7. The method of claim 1, further comprising:
automatically rating each interaction between the mobile electronic device and the service provider, wherein the rating for each interaction is used for future service provider determination.

8. The method of claim 1, further comprising:
providing an exchange between multiple businesses for assigning the at least one service communication channel and the service provider.

9. A computer program product for managing customer service requests, the computer program product comprising a computer readable storage device having program instructions embodied therewith, the program instructions executable by a processor to cause the processor to:
issue a customer service request for a mobile electronic device;
obtain customer preferences for the issued customer service request;
dynamically determine a match between the obtained customer preferences with at least one of a business preference and rules;
dynamically monitor signals provided by the mobile electronic device and electronic devices in a venue to determine one or more patterns for the mobile electronic device; and
assign at least one service communication channel and a service provider for the customer service request to provide interaction between the service provider and the mobile electronic device based on the match, the one or more patterns and service provider availability.

10. The computer program product of claim 9, wherein:
the service provider availability is determined based on interfacing with one or more scheduling applications; and
the service provider is at least one of: located in the venue, remotely located to the venue, and is a virtual service provider representative.

11. The computer program product of claim 1, wherein:
the issued customer service request is initiated by at least one of: a vicinity handshake with the mobile electronic device, a vicinity view determination, receiving initiation from the mobile electronic device and an automatic issuance received by the mobile electronic device; and
the customer preferences are obtained from a profile that comprises preferences for at least one of: type of service communication channel, types of customer service providers and particular customer service providers.

12. The computer program product of claim 11, wherein:
the type of service communication channel comprises: an in person service communication channel, an audio based service communication channel using the mobile electronic device, a text message based service communication channel, or a video based service communication channel using the mobile electronic device; and
the business preference and rules are based on at least one of: general policies, customer specific policies, based on customer selected billing preferences and interaction time limits.

13. The computer program product of claim 9, further comprising program instructions executable by the processor to cause the processor to:
automatically rate each interaction between the mobile electronic device and the service provider, wherein ratings for each interaction are used for future service provider determination.

14. The computer program product of claim 9, further comprising program instructions executable by the processor to cause the processor to:
provide a cloud-based exchange between multiple businesses for assigning the at least one service communication channel and the service provider.

15. A system comprising:
a memory storing instructions; and
at least one processor executing the instructions including obtaining a customer service request for a mobile electronic device, obtaining customer preferences for the customer service request, determining a match for the customer preferences with at least one of a business preference and rules, determining one or more patterns for the mobile electronic device based on monitoring signals provided by the mobile electronic device and electronic devices in a venue, and assigning at least one service communication channel and a service provider for the customer service request to provide interaction between the service provider and the mobile electronic device based on the match, the one or more patterns and service provider availability.

16. The system of claim 15, wherein:
the service provider availability is determined based on the at least one processor interfacing with one or more scheduling applications; and
the assigned service provider is at least one of: located in the venue, remotely located to the venue, and a virtual service provider representative.

17. The system of claim 15, wherein:
the issued customer service request is initiated by at least one of: a vicinity handshake with the mobile electronic device, a vicinity view determination, receiving initiation from the mobile electronic device and an automatic issuance received by the mobile electronic device; and
the customer preferences are obtained from a profile that comprises preferences for at least one of: type of service communication channel, types of customer service providers and particular customer service providers.

18. The system of claim 17, wherein:
the type of service communication channel comprises: an in person service communication channel, an audio based service communication channel using the mobile electronic device, a text message based service communication channel, or a video based service communication channel using the mobile electronic device; and
the business preference and rules are based on at least one of: general policies, customer specific policies, based on customer selected billing preferences and interaction time limits.

19. The system of claim 15, wherein the at least one processor further executes instructions comprising automatically rating each interaction between the mobile electronic device and the service provider, and ratings for each interaction are used for future service provider determination.

20. The system of claim 15, wherein the at least one processor further executes instructions comprising managing an exchange between multiple services for assigning the at least one service communication channel and the service provider.
